(19) United States
(12) Patent Application Publication
(10) Pub. No.: US 2026/0066831 A1
(43) Pub. Date: Mar. 5, 2026

(54) METHOD FOR MEASURING A DAMPING FUNCTION

(71) Applicant: Liebherr-Aerospace Lindenberg GmbH, Lindenberg (DE)

(72) Inventors: Thomas IMMLER, Sigmarszell (DE); Christian SCHILLING, Maierhöfen (DE); Julian KINZELMANN, Hergensweiler (DE)

(21) Appl. No.: 19/319,247

(22) Filed: Sep. 4, 2025

(30) Foreign Application Priority Data
Sep. 4, 2024 (DE) 10 2024 125 264.2

(51) Int. Cl. H02P 29/024; H02P 23/04

(52) U.S. Cl. CPC H02P 29/024; H02P 23/04; H02P 2207/05

(57) ABSTRACT

The present disclosure relates to a method for measuring a damping function, for example of a damper of an electromechanical actuator or drive system, and to an actuator or a drive system comprising a control unit which is configured for carrying out a method according to the disclosure. The method comprises the steps of actively accelerating a motor to a defined speed n, activating an isolation function and/or switching off a converter and/or configuring the converter for generating a short circuit of the connected phases, and determining a current step response of the motor.

### CROSS REFERENCE TO RELATED APPLICATION

The present application claims priority to German Patent Application No. 10 2024 125 264.2 filed on Sep. 4, 2024. The entire contents of the above-listed application are hereby incorporated by reference for all purposes.

### TECHNICAL FIELD

The present disclosure relates to a method for measuring a damping function, preferably of a damper of an electromechanical actuator or drive system, and to an actuator or a drive system comprising a control unit which is configured for carrying out a method according to the disclosure.

### BACKGROUND

In the case of conventional actuators or drive systems comprising a damper, additional, specialised hardware, for example in the form of a particular electronics or sensor means, is present for measuring or checking the damping function.

### SUMMARY

This leads to a significant additional structural outlay.

The object of the present disclosure is that of providing a simplified possibility for checking or measuring a damping function.

This object is achieved by the method as described herein.

According thereto, a method for measuring a damping function, for example of a damper of an electromechanical actuator or drive system, is provided, comprising the steps of:
active acceleration of a motor to a defined speed n,
activating an isolation function and/or switching off a converter and/or configuring the converter for generating a short circuit of the connected phases,
determining a current step response of the motor.

According to the disclosure, specialised hardware for measuring the damping function may be thus omitted, and the damping function is determined by a current measurement, in particular by determining a current step response of the motor. The omitted specialised hardware may be position sensors, force sensors, or velocity or acceleration sensors, for example.

This has the advantage that exclusively hardware components may be used which are present in any case in the actuator or drive system, and specialised hardware can be omitted.

According to one embodiment, the method according to the disclosure comprises the following steps:
checking whether the current step response corresponds to an expectation value, for example whether a defined amplitude has been reached, and thus a preset damping value is reached, wherein, illustrated simply, the amplitude of the current step follows the following relationship: I=U/Z, where U=n*ke and Z=(Rmotor+Rdamping+jwLMotor)

Furthermore, a method according to the disclosure can comprise at least one of the following steps:
determining at least one motor torque by means of a determination of the position difference between a motor position and an actuator position, and/or
checking whether the speed of at least one recorded change of at least one motor torque corresponds to a required damping at the motor level, and/or
determining a rotational speed change associated with the activation of the damping function, and/or determining a time until a defined speed change occurs, and/or determining a time until standstill of the motor.

A characteristic motor equation can be created from the determined at least one motor torque.

Optionally, a method according to the disclosure furthermore comprises the step of:
performing a parameter identification, in particular of the parameters L, R, kt, by means of a generated characteristic motor equation optionally generated on the basis of the at least one motor torque, or an observer model.

Alternatively or in addition, a method according to the disclosure can comprise the following step:
determining a phase resistance of the motor during standstill, and correcting the phase resistance of the motor if the phase resistance of the motor deviates from a target value or tolerance range.

An advantage of the method according to the disclosure is that the method does not require any specific hardware designated for carrying out the method.

Another aspect of the present disclosure relates to a drive system for an actuator, comprising a control unit which is configured for carrying out a method according to the present disclosure.

The present disclosure furthermore relates to an electromechanical actuator comprising a drive system according to the present disclosure.

Moreover, the present disclosure relates to an aircraft comprising a drive system and/or an electromechanical actuator according to the present disclosure.

A drive system and an actuator, in the context of which the present disclosure can optionally be used, are described in more detail below.

The drive system according to the disclosure for an actuator, for example an electromechanical actuator for use in an aircraft, optionally comprises an electric motor for outputting a torque for actuation of the actuator, a first drive electronics which is configured to provide electrical power to a motor connection for driving the electric motor, a second drive electronics which is configured for providing electrical power to the motor connection for driving the electric motor, a first isolation device which is provided in a connection between the first drive electronics and the motor connection and electrically isolates the first drive electronics from the motor connection in an active state, a second isolation device which is provided in a connection between the second drive electronics and the motor connection and electrically isolates the second drive electronics from the motor connection in an active state, and a damping unit which is connected to the electric motor via the motor connection and serves, if required, to increase a movement resistance of the electric motor, wherein the first drive electronics and the second drive electronics are redundant relative to one another, and the damping unit is configured for recording the state of the first isolation device and the state of the second isolation device and bringing about damping of the electric motor if both the isolation devices are in their active state.

It is thus optionally provided that there is a first drive electronics and a second drive electronics, which are configured to be redundant relative to one another. In this case, the first drive electronics or the second drive electronics is configured to control the electric motor such that the drive system is configured to be redundant, with respect to the electrical part of the drivetrain, by duplication of the corresponding components.

In addition to this redundant design, furthermore another damping unit is also provided, which damps the movement of the electric motor if neither the first drive electronics nor the second drive electronics is able to control the motor via a corresponding electrical power output to the motor connection.

In this case, the damping unit is equipped with sensors which check the active or inactive state of a respective isolation device associated with a drive electronics.

If both the first isolation device, which is associated with the first drive electronics, and the second isolation device, which is associated with the second drive electronics, is in the active state, both the drive electronics are thus electrically isolated with respect to the motor connection and can therefore not control the motor, then the damping unit causes damping of the electric motor in order to prevent oscillations of the element that is to be controlled by the actuator.

An advantage of this is that the drive system according to the disclosure also considers the situation when both redundant drive electronics are no longer able to control the electric motor. For this case, the damping unit takes over and ensures damping of the electric motor, such that oscillations of the element actuated by the actuator are suppressed.

According to an optional development of the present disclosure, the first isolation device and the second isolation device can in each case be switched by a switch, for example a converter, which interrupts the electrical connection between the associated drive electronics and the motor connection of the electric motor, if required.

This ensures that if the drive unit outputs faulty signals for controlling the electric motor, these are no longer transmitted to the motor connection.

Furthermore, the provision of the isolation device is advantageous, since the drive electronics that is not in operation and that is used only in the case of a malfunction of the drive electronics in operation is also protected from any feedback of the first drive electronics or of the motor connection, with the aid of the isolation device.

Finally, the isolation device of the drive electronics not used for operating the motor is also electrically separated or isolated from the motor connection with the aid of a switch, for example converter, or the like.

Accordingly, according to an embodiment of the present disclosure, it can be provided that the first isolation device and the second isolation device are configured such that at least one of the first drive electronics and the second drive electronics is electrically isolated from the motor connection. As already set out above, the switching of the electric isolation device by a switch can be considered advantageous.

According to a further optional development of the present disclosure, it can be provided that the first drive electronics and the second drive electronics are each configured for changing between an active mode for controlling the electric motor and a control mode for monitoring the drive system, in particular of the electric motor and/or of the other drive electronics, wherein the control mode serves for monitoring a fault-free state.

In this case, advantageously one of the two drive electronics is in an active mode and the other of the two drive electronics is in a control mode, such that the situation where both drive electronics transmit signals to the electric motor simultaneously does not occur.

At least one of the two drive electronics is electrically isolated from the electric motor with the aid of the two isolation devices, such that simultaneous transmission of control signals to the motor connection is not possible.

In this case, it can be provided that the first drive electronics and the second drive electronics are each configured, in the control mode, to activate the isolation device of the other drive electronics in the event of detection of a faulty state, and to change into the active mode, in order to take over the control of the electric motor.

In a control mode, although the drive electronics in the control mode is electrically separated from the electric motor by an active state of the isolation device, each of the two drive electronics receives the same input signals, irrespective of what mode the drive electronics are in, and therefor a drive electronics in the control mode can monitor the drive electronics in the active mode.

For this purpose, for example a comparison is made of what signals the drive electronics in the active mode outputs, and whether this corresponds to the signals that the drive electronics in the control mode would have output on the basis of the received input signals. If there is a deviation in this respect, the drive electronics in the control mode can seek to change into the active mode, wherein firstly the isolation device of the drive electronics considered faulty is set into the active state, and the isolation device of the drive electronics still in the control mode is deactivated, such that the formerly electrically isolated drive electronics is now connected to the motor connection of the electric motor.

Thus, if a drive electronics in the control mode has identified a fault of the drive electronics in the active mode, a mode change of the drive electronics in the control mode can be carried out, which simultaneously leads to the drive electronics considered as defective being removed from the control of the electric motor by transferring the isolation device into the active state.

According to a further optional modification of the present disclosure, it can be provided that the first drive electronics and the second drive electronics are each configured, in the active mode, to monitor themselves and, in the event of identification of a faulty state, to activate the associated isolation device.

Optionally, in the case of a self-detected fault state of a drive electronics, a signal for taking over the control of the electric motor can also be transmitted to the other drive electronics, such that the actual drive electronics in the control mode takes over the control of the motor. However, if the other drive electronics has also detected a fault in itself, or if a fault has been discovered by a superordinate control entity, it is possible that the other drive electronics does not fulfil this demand, such that the state occurs in which both drive electronics are electrically separated from the motor by their associated isolation device, such that no electrical power is supplied thereto.

Such a state is detected by the damping unit, which thereupon brings about damping of the electric motor. Thus, provision is also made for the event of both drive electronics, configured redundantly with respect to one another, failing or assuming a state that is not completely fault-free, but nonetheless an undamped state of an electromechanical actuator provided with the drive system according to the disclosure does not occur, since the electric motor driving the actuator is damped by the damping unit.

According to a development of the present disclosure, it can be provided that the first drive unit and the second drive unit are linked to identical input signals for actuating the electric motor, which signals are used, in a control mode, for monitoring the other drive unit that is in the active mode, in particular by adjusting a motor speed, and/or a current value and/or voltage value delivered by the other drive unit to the motor connection.

The drive electronics that is available owing to the redundant configuration is thus also supplied with the input signals for actuating the drive electronics if an output of the signals to the electric motor is not actually provided, since this is taken on by the other drive electronics.

The background to this is that the supplying of the input signals to the drive electronics available redundantly is used for monitoring the other drive electronics. In this case, the input signals are thus processed as though the drive electronics made available redundantly were actually connected to the electric motor, such that an adjustment can take place if the control signals for the motor, generated by the drive electronics made available redundantly, deviate from the control signals of the other drive electronics.

If this is the case, the drive electronics made available redundantly can leave the control mode and change into the active mode, wherein the other drive electronics is separated, by transfer of the associated isolation device (by signalling from the other drive electronics) into the active state, from a connection to the electric motor.

According to a further optional development of the present disclosure, it can be provided that in a fault-free state of the drive system one drive electronics is in the active mode and the other drive electronics is in the control mode.

This corresponds to a normal state of the drive system according to the disclosure, since one of the two drive electronics actually generates the signals that are supplied to the electric motor, and the other drive electronics is made available redundantly and its connection to the motor connection of the electric motor is interrupted with the aid of the isolation device.

According to an embodiment of the present disclosure it can be provided that the motor connection comprises a plurality of lines which are connected to a respective phase of the electric motor.

Typically, each of the two drive electronics is configured for outputting a specific power signal for each phase of the motor, for example such a signal that has a specific current value and a specific voltage value.

It can be provided according to the disclosure that the electric motor is a permanent magnet synchronous motor or a brushless direct current motor. In this case, the commutation of the electric motor corresponds to a standard commutation.

In this case, according to a further embodiment of the present disclosure it can be provided that the damping unit is configured for short-circuiting the phases of the motor, in order to generate a resistance against a rotational movement of the motor. This brings about a simple implementation of a damping during the movement of the motor.

It can furthermore be provided, according to an embodiment of the present disclosure, that the damping unit is configured for switching the phases of the motor to an electric or electronic load, in order to generate a resistance against a rotational movement of the motor. This also brings about a simple implementation of a damping during the movement of the motor.

Furthermore, it can be provided according to an embodiment of the present disclosure that the damping unit is integrated in the electric motor.

The disclosure furthermore relates to an electromechanical actuator comprising a drive system according to any of the aspects discussed above.

In this case, it can be provided, according to an optional embodiment of the present disclosure, that the actuator is configured for use in a primary flight control of an aircraft.

Thus, the actuator can serve for example for actuating an air guide surface of an aircraft, and therefore the advantages of the drive system according to the disclosure take particular effect here.

At this point it is noted that the terms “a” and “an” do not necessarily relate to exactly one of the elements, even if this is a possible implementation, but rather can also denote a plurality of the elements. Likewise, the use of the plural also does not exclude the presence of the element in question in the singular, and, vice versa, the singular also includes a plurality of the elements in question.

Furthermore, all the features of the disclosure described herein can be combined with one another as desired or claimed in isolation from one another.

Further details and advantages of the disclosure are explained in more detail with reference to the embodiments shown in the drawings. The same reference signs denote identical or similar components.

### BRIEF DESCRIPTION OF THE FIGURES

In the drawings:

FIG. 1: is a schematic view of a drive system to which the present disclosure is applicable;

FIG. 2: is a schematic view of a drive system according to the present disclosure,

FIG. 3: is a schematic view of another drive system according to the present disclosure, and

FIG. 4: is a view by way of example of a recorded current step response which reflects the damping function.

### DETAILED DESCRIPTION

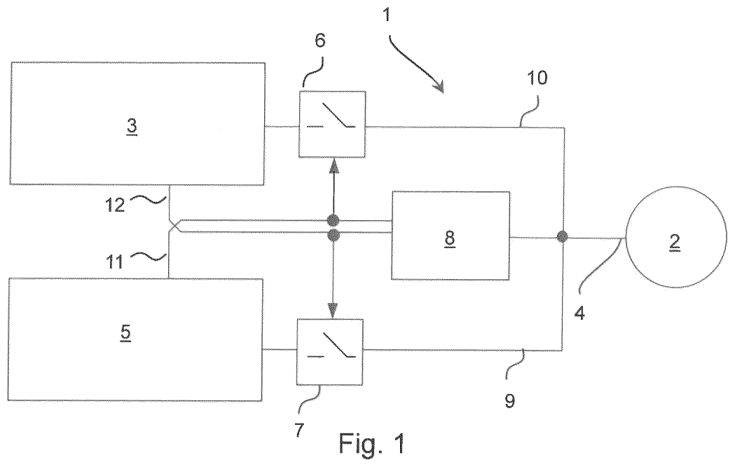

In FIG. 1, the electric motor 2 that serves for actuating an actuator is visible. Furthermore, a first drive electronics 3 and a second drive electronics 5 is provided, which are each configured in a redundant manner relative to one another. In this case, each of the two drive electronics 3, 5 is actuated via input signals (not shown) which for example sense the position of a controller in order to bring about a control of the actuator, connected to the electric motor 2, that corresponds to the controller position.

For this purpose, each of the two drive electronics 3, 5 is connected to a motor connection 4 of the electric motor 2. In order to in the process keep the number of lines small, the electric motor connection 4 is present just once and can receive corresponding signals for controlling the electric motor 2 from each of the two drive electronics 3, 5. According thereto, a signal for actuating the electric motor 2 is transmitted from the first drive electronics 3 via a line 10 which is connected to a line 9 that is used for actuating the electric motor 2 from the second drive electronics 5.

However, in order that divergent or double actuation of the electric motor 2 via the motor connection 4 does not occur, an isolation device 6, 7 is provided in each of the lines 9, 10, which isolation device is configured to electrically isolate the associated drive electronics 3, 5. This can be implemented for example by providing a switch, which is transferred into its open position such that isolation of the associated drive electronics 3, 5 occurs.

In control operation, one of the two drive electronics 3, 5 is responsible for controlling the electric motor 2, such that corresponding actuation signals have to be sent to the motor connection 4 of the electric motor 2 from the drive electronics 3, 5 responsible for controlling the electric motor 2. In this case, it is thus provided that one of the two isolation devices 6, 7 is in its inactive state, which allows for signals output by an associated drive electronics 3, 5 to be conducted to the motor connection 4.

The other drive electronics 3, 5, the associated isolation device 6, 7 of which is in its active state, accordingly cannot act on the electric motor 2, since the signals actually intended for conducting to the motor connection 4 are not passed along owing to the isolation device and the resulting electrical isolation.

Furthermore, the damping unit, provided with the reference sign 8, can also be seen, which damping unit is also connected to the motor connection 4 of the electric motor 2. This can short-circuit the different phases of the electric motor 2 together if required, or interconnect them via an electric or electronic load, which brings about damping of the electric motor 2.

In this case, the damping unit is configured to record the state of the two isolation devices 6, 7 and to bring about damping of the electric motor 2 depending thereon. Damping of the motor 2 is carried out only if the state is detected that both isolation devices 6, 7 are in their active state, which means that neither the first drive electronics 3 nor the second drive electronics 5 has an electrical connection to the motor connection 4 of the motor 2, and therefore the motor 2 does not receive any control signals. In order to now prevent undesired oscillations occurring due to external influences, for example an air flow at an air guide element of an electromechanical actuator, which is provided with the drive system according to the disclosure, which oscillations can cause damage to components of the drive system or even neighbouring components in the integrated structure of the drive system, the damper unit acts on the motor 2 in a damping manner.

Furthermore, the lines 11, 12 are visible, which extend from one drive electronics 3, 5 to the isolation device 6, 7 of the other drive electronics 3, 5. Since it is clear that the two drive electronics 3, 5 cannot transmit control signals to a motor connection 4 of the motor 2 simultaneously, there is one drive electronics 3, 5 that is in an active state, and another drive electronics 3, 5 that is in what is known as a control mode.

In this control mode, the drive electronics 3, 5 is electrically isolated from the motor connection 4 with the aid of the associated isolation device 6, 7, such that any outputs of the drive electronics 3, 5 are not passed on to the motor connection 4. However, each of the two drive electronics 3, 5 is capable of monitoring the drive system in the control mode, in particular to monitor the drive electronics 3, 5 in the active mode, the electric motor 2 or its parameter such as rotational speed, torques or the like, or also the actuation signals output by the drive electronics 3, 5 that is in the active state.

If the drive electronics 3, 5 in the control mode displays a deviation with respect to the values it considers correct, the drive electronics 3, 5 that is in the control mode can seek to change into the active mode, and at the same time remove the drive electronics 3, 5 previously in the active mode from the control of the electric motor 2. This is achieved in that the drive electronics 3, 5 in the control mode activates the isolation device 6, 7 of the other drive electronics 3, 5 and deactivates the other isolation device 6, 7, such that now the drive electronics 3, 5 that was previously in the control mode can take over an actuation of the motor 2.

If, in contrast, faults are identified in both drive electronics 3, 5, either by itself, a superordinate control entity and/or the other drive electronics 3, 5, neither of the two drive electronics 3, 5 is available for actuation of the electric motor 2, such that the damping unit 8 records an active state of the two isolation devices 6, 7 and brings about damping of the motor 2.

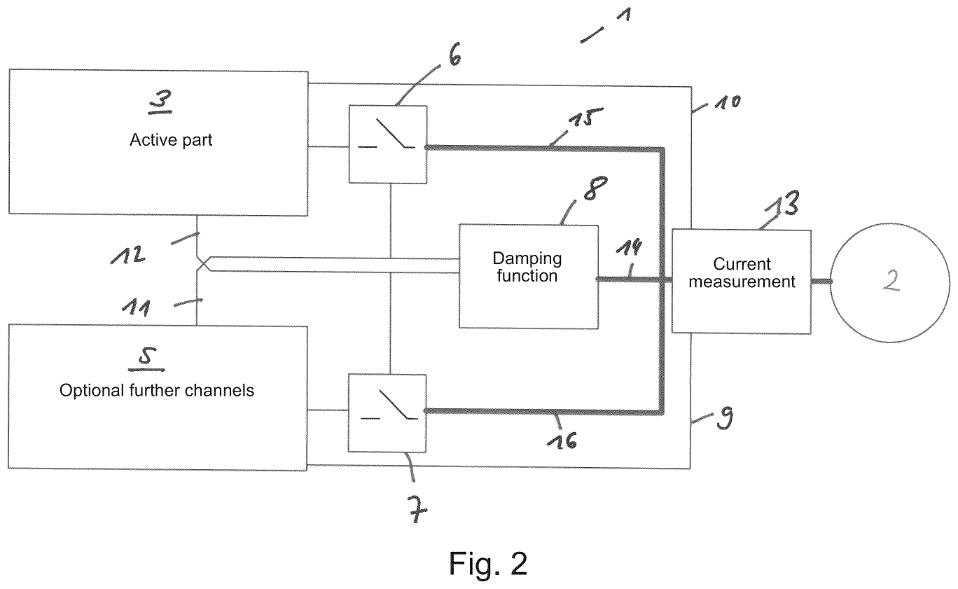

FIG. 2 shows, in addition to the components known from FIG. 1, a means 13 for current measurement. The means 13 for current measurement is connected to the damping unit (also referred to as damping function) 8 by a line 14. The current for controlling the motor, as well as the current via the damping function, are provided by the means 13 to all channels, for example the units 3 and 5. The means 13 for current measurement may be, for example, a shunt resistor or a Hall-effect sensor.

The isolation devices 6 and 7 or converter are also coupled to the line 14, and thus to the means 13 for current measurement, by means of lines 15 and 16.

A control unit (not shown) can be configured for determining the motor inductance during standstill, on the basis of the following relationships, and can optionally perform a correction of the motor inductance.

$${i}_{d} = - \frac{{L}_{q} \cdot {ω}^{2} \cdot {k}_{t} \cdot p}{{R}^{2} + {L}_{d} \cdot {L}_{q} \cdot {ω}^{2} \cdot {p}^{2}} {i}_{q} = - \frac{R \cdot ω \cdot {k}_{t}}{{R}^{2} + {L}_{d} \cdot {L}_{q} \cdot {ω}^{2} \cdot {p}^{2}}$$

From the relationship:

$${I}_{K} = \frac{{U}_{EMF}}{{Z}_{sp}} {U}_{EMF} = \frac{ω \text{?} \cdot k \text{?}}{{z}_{p}} {Z}_{sp} = \sqrt{{R}^{2} + {( ω \text{?} L )}^{2}}$$

$$\text{?} \text{indicates text missing or illegible when filed}$$

the following furthermore follows for the short-circuit current:

$${I}_{K} = \frac{{ω}_{e} \cdot {k}_{e}}{{z}_{p}} \frac{1}{\sqrt{{( {R}_{motor} + {R}_{damp} )}^{2} + {( {ω}_{e} L )}^{2}}}$$

The limit value for I for w towards infinity results as follows:

$$lim \text{?} {I}_{K}^{2} = lim \text{?} \frac{ω \text{?} k \text{?}}{{z}_{p}^{2} \cdot ( {R}^{2} + {ω}_{s}^{2} {L}^{2} )} = \frac{k \text{?}}{{z}_{p}^{2} \cdot {L}^{2}}$$

$${I}_{K} ( ω \text{?} \to ∞ ) = \frac{k \text{?}}{{z}_{p} \cdot L}$$

$$\text{?} \text{indicates text missing or illegible when filed}$$

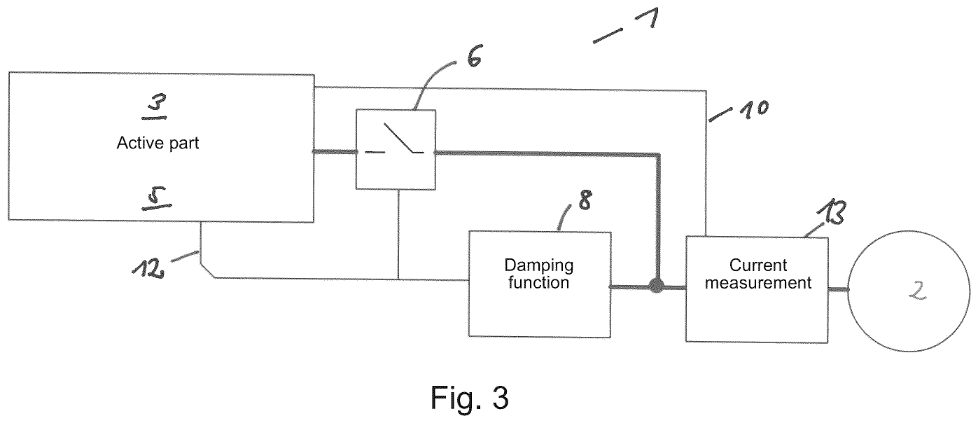

As shown in FIG. 3, the second drive electronics 5 is in principle optional, and it is also possible that just one first drive electronics 3 may be provided.

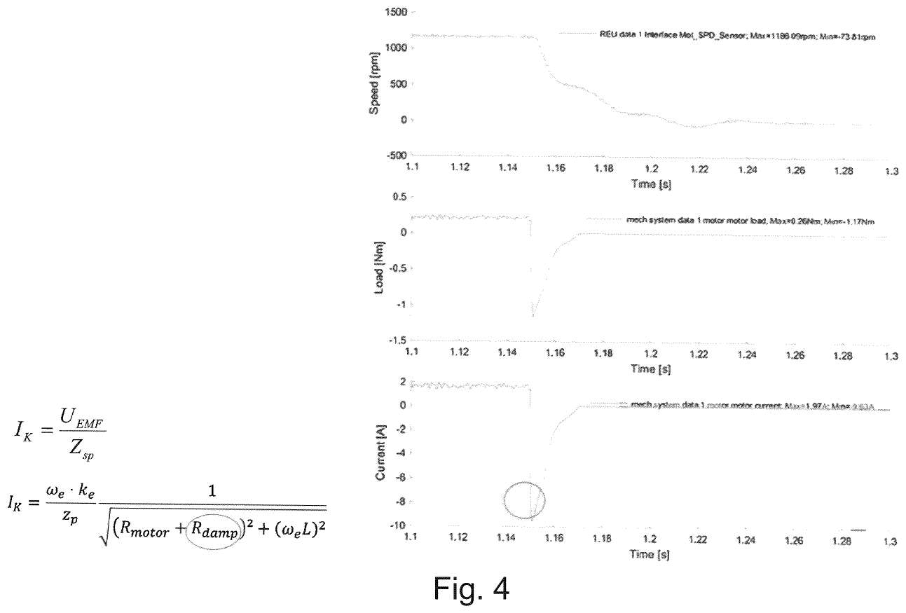

FIG. 4 is a view by way of example of a recorded current step response which reflects the damping function.

In the bottom panel, the region representing the current step response is identified with a circle. This is linked to the resistance of the damper unit R_{damp} in the accompanying equation, and thus allows for conclusions regarding the damper function.

### LIST OF REFERENCE SIGNS

1 drive system
2 electric motor
3 first drive electronics
4 motor connection
5 second drive electronics
6 first isolation device
7 second isolation device
8 damping unit
9 line(s) for actuating the motor of the second drive electronics
10 line(s) for actuating the motor of the first drive electronics
11 line of the second drive electronics for activating the first isolation device
12 line of the first drive electronics for activating the second isolation device
13 means for current measurement
14 line between damping unit and means for current measurement
15 line between first isolation device and line 14
16 line between second isolation device and line 14

1. A method for measuring a damping function, comprising the steps of:
active acceleration of a motor to a defined speed n,
activating an isolation function and/or switching off a converter and/or configuring the converter for generating a short circuit of connected phases, and
determining a current step response of the motor.

2. The method according to claim 1, furthermore comprising the steps of:
checking whether the current step response corresponds to an expectation value.

3. The method according to either claim 1, furthermore comprising the steps of:
determining at least one motor torque by means of a determination of a position difference between a motor position and an actuator position, and
checking whether the speed of at least one recorded change of at least one motor torque corresponds to a required damping at the motor level, and/or
determining a rotational speed change associated with the activation of the damping function, and/or determining a time until a defined speed change occurs, and/or determining a time until standstill of the motor.

4. The method according to claim 1, further comprising the step of:
performing a parameter identification, of parameters L, R, kt by means of a generated characteristic motor equation or an observer model.

5. The method according to claim 1, further comprising the step of:
determining a phase resistance of the motor during standstill and correcting the phase resistance of the motor if the phase resistance of the motor deviates from a target value or tolerance range.

6. The method according to claim 1, wherein the method does not require any specific hardware designated for carrying out the method.

7. A drive system for an actuator, comprising a control unit which is configured for carrying out the method according to claim 1.

8. An electromechanical actuator comprising the drive system according to claim 7.

9. An aircraft comprising the electromechanical actuator according to claim 8.

10. The method according to claim 1, wherein the method measures a damping function of a damper of an electromechanical actuator or drive system.

11. The method according to claim 2, wherein checking whether the current step response corresponds to the expectation value comprises checking whether a defined amplitude has been reached, and thus a preset damping value is reached.
